(19) United States
(12) Patent Application Publication
(10) Pub. No.: US 2009/0319288 A1
(43) Pub. Date: Dec. 24, 2009

(54) SUGGESTING CONTACTS FOR SOCIAL NETWORKS

(75) Inventors: Malcolm Slaney, Sunnyvale, CA (US); Alex Jaffe, Seattle, WA (US); Shanmugasundaram Ravikumar, Berkeley, CA (US); Aris Anagnostopoulos, San Francisco, CA (US); Michael Mahoney, Redwood City, CA (US); Mohammad Mahdian, Santa Clara, CA (US); Matthew Rothenberg, Oakland, CA (US); Arpita Ghosh, Santa Clara, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo Inc., Sunnyvale, CA (US)

(21) Appl. No.: 12/145,436

(22) Filed: Jun. 24, 2008

(51) Int. Cl. G06Q 99/00

(52) U.S. Cl. 705/1

(57) ABSTRACT

A social network is managed by applying connectivity and similarity measures to social network information to identify possible new relationships between social network users, and then automatically suggest those identified relationships to the social network users. The social network information can include user profile information and indicate existing social relationships between the users in the social network. Users can provide feedback regarding the suggestions, including indications whether the relationship was accepted, consummated, or declined. The social network information can be updated using the feedback. Similarity measures can be based on one or more of shared contacts, or common interests or activities, or content associated with social network users, or ratings within the social network of users and/or their content. Possible relationships having similarity measures that suggest the users likely to already know each other, can be omitted and not suggested.

### TECHNICAL FIELD

The present invention relates generally to managing network information, and more particularly to managing and encouraging connections between users in social networks.

### BACKGROUND

Tremendous changes have been occurring in the Internet that influence our everyday lives. For example, online social networks have become the new meeting grounds. The development of online social networks touch countless aspects of our everyday lives, providing instant access to people of similar mindsets, and enabling us to form partnerships with more people in more ways than ever before.

Social network users can meet or contact other social network users and form relationships with them, when users participate in online forums, chat rooms, or email lists whose theme or subject is of common interest to those participating users. However, this can require time and effort on the part of users and may not result in contact between all users that may have significant interests in common or potential to form rewarding relationships. In addition, actions of individual users may fail to recognize or consider relationships that can benefit the social network as a whole. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention;

FIG. 4 illustrates a logical flow diagram showing an embodiment of a process in accordance with the invention; and

FIG. 5 illustrates a logical flow diagram that shows an example implementation of block 404 of FIG. 4 in accordance with an embodiment of the invention.

### DETAILED DESCRIPTION

The present invention now will be described more fully hereinafter with reference to the accompanying drawings, which form a part hereof, and which show, by way of illustration, specific embodiments of the invention. However, this invention may be embodied in many different forms and should not be construed as limited to the embodiments set forth herein. Rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. Therefore, the following detailed description is not to be taken in a limiting sense.

Throughout the specification and claims, the following terms take the meanings explicitly associated herein, unless the context clearly dictates otherwise. The phrase “in one embodiment” does not necessarily refer to the same embodiment, although it may. Furthermore, the phrase “in another embodiment” does not necessarily refer to a different embodiment, although it may. Thus, as described below, various embodiments of the invention may be readily combined without departing from the scope or spirit of the invention.

As used herein, the term “social network” refers generally to a network of acquaintances, friends, family, colleagues, and/or coworkers, and potentially the subsequent connections within those networks. A social network, for example, can be utilized to find more relevant connections for a variety of activities, including, but not limited to dating, job networking, receiving or providing service referrals, content sharing, creating new associations or maintaining existing associations with like-minded individuals, finding activity partners, performing or supporting commercial transactions, or the like.

A person's online social network refers to the person's set of direct and/or indirect personal relationships, including real and virtual privileges and permissions that may be associated with those relationships, for example privileges and permissions set by one or more of the parties in a relationship. Direct personal relationships refers to relationships with people the user communicates with directly, including family members, friends, colleagues, coworkers, and/or other people with which the person has had some form of direct contact, such as contact in person, by telephone, by email, by instant message, by letter, or the like. These direct personal relationships are sometimes referred to as first-degree relationships. First-degree relationships can have varying degrees of closeness, trust, and other characteristics.

Indirect personal relationships refer to relationships through first-degree relationships to people with whom a person has not had some form of direct or limited direct contact, such as in being cc'd on an email message, or the like. For example, a friend of a friend represents an indirect personal relationship. A more extended, indirect relationship might be a friend of a friend of a friend. These indirect relationships are sometimes characterized by a degree of separation between the people. For instance, a friend of a friend can be characterized as two degrees of separation or a second-degree relationship. Similarly, a friend of a friend of a friend can be characterized as three degrees of separation or a third-degree relationship, and so forth.

A social network generally includes individuals with similar experiences, opinions, education levels and/or background, or is organized into subgroups according user profile, where for example a member can belong to multiple subgroups (profession—engineer, hobby—photography, geographic location—Northern California). For social searches or inquiries, a person's first-degree social network can be a great source of information. The reason is that the direct relationship with the individuals is likely to lead to more relevant information, more forthcoming and complete responses and responses from individuals with similar experience, opinions, education levels, background, and so on.

Social networks can be structured, or supported by mechanisms or organizations that can govern and/or support interactions within the social network, membership of the social network, and use of resources within the network, as well as flow of information across boundaries of the network. For example, a social network can be a “walled garden”, where members or other designated persons can enter the garden and the “wall” can have various levels of porosity, transparency and security. Examples of structured social networks include Facebook, Yahoo 360, and MySpace. Networks that host content in connection with individual user accounts and permit access to the hosted content to members and guests of the network according to various conditions, such as Flickr and YouTube, are also variants of social networks. A mobile device that includes contact and other information for different people, for example names, telephone numbers, email or other electronic addresses, pictures and so forth, can also be or represent a social network or structured social network.

The following briefly describes the embodiments of the invention to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, example embodiments are directed toward suggesting new contacts or relationships to users of a social network, where the possible new contacts or relationships are determined based on both how such new contacts would affect connectivity within the network, and on similarities or potential affinities between the user and the suggested contact. Possible new contacts can then be suggested to users that would be affected, for example by automatically sending a message to a user with a recommendation or suggestion to contact another user.

A social network can be healthier and more active when its user population is more active, and when more people in the network interact with each other. In particular, connections or relationships that increase connectivity of the social network, e.g. permit information or ideas to traverse the network more quickly and thoroughly, benefit the social network. Thus in example embodiments, such possible contacts or relationships between social network users are identified. Similarities between social network users that would form or consummate these relationships are also identified and evaluated, since in one embodiment there is a goal to enhance or maximize a likelihood that users will accept and suggested contacts or relationships that would benefit the network. In other words, user similarities can be used to screen or select among possible connections that would benefit the network so that connections that users would likely accept, establish and build upon are suggested, and those that are less likely to be accepted are not suggested. This can enable efficient use of social network resources and increase users' willingness to favorably consider suggested connections or relationships.

In example embodiments of the invention, network connectivity measures and user similarity measures are determined and then combined, for example by multiplying the measures together, and the result of the combination is evaluated to determine or identify possible new relationships or contacts between users in the social network, that would both improve a connectivity of the network and have an acceptable likelihood of being accepted and adopted by the users they would involve.

In example embodiments, factors considered to determine degrees of similarity between different users in a social network include one or more of second order contacts in common (e.g., number of friends in common), similarity between a user's friends and other users being considered as contacts to suggest. Other factors include a threshold number of generally uncommon tags or interests that different users have in common. A degree of overlap in interests can also be considered, for example a number of interests, use groups, chat rooms and so forth that the users being considered for suggested contact all have or belong to. In an example embodiment, the number is constrained between two thresholds. The two thresholds include a minimum threshold to ensure that there is some common ground and thus a likelihood that a user will accept the suggestion, and also a maximum threshold to avoid suggesting contact to users that are likely to already know each other.

In example embodiments other similarity factors are additionally or alternatively considered, in social networks where images such as photographs, or content other than images (e.g. music, blogs, and so forth) are associated with different users. In that scenario, contact can be suggested between users whose content shares similar ratings from other users, and where the ratings are optionally higher than a minimum threshold. Thus, a user that is considered to be an expert of a given rank or class, or an owner of content of a given quality or popularity level, can be suggested as a contact to another user of similar rank or level. Suggestions can be asymmetric, e.g. one user is suggested to another but not vice versa, or suggestions can be symmetric, where users are suggested to each other. Similarity of the content itself can also form a basis of similarity.

In an example embodiment, results of suggestions for contact are tracked, for example so that once a user has declined a suggestion to contact another particular user, that suggestion will not be repeated.

### Illustrative Operating Environment

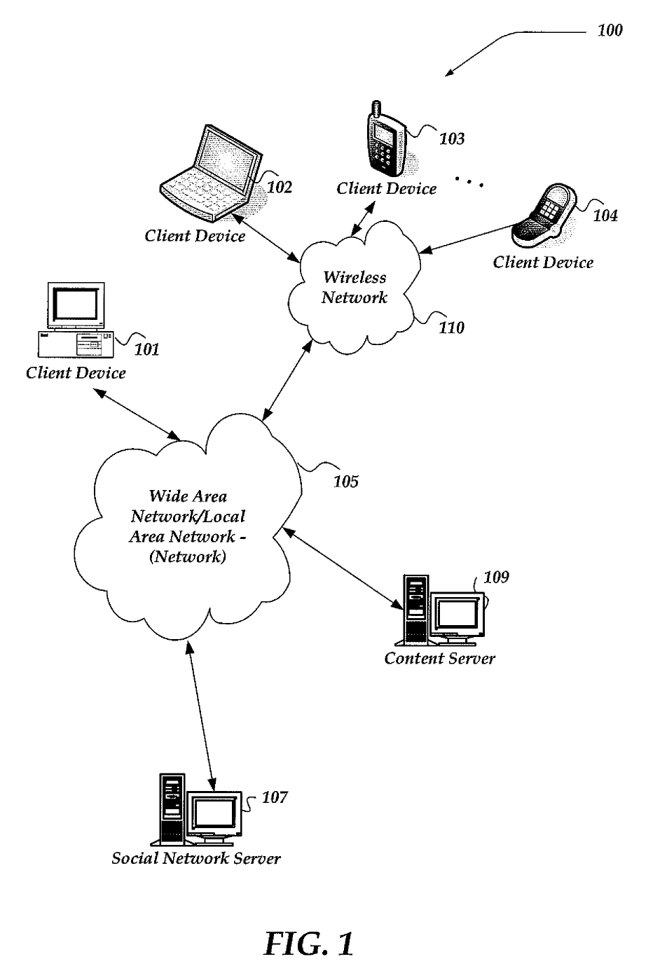

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)−(network) 105, wireless network 110, client devices 101-104, a Social Network server 107, and a Content server 109.

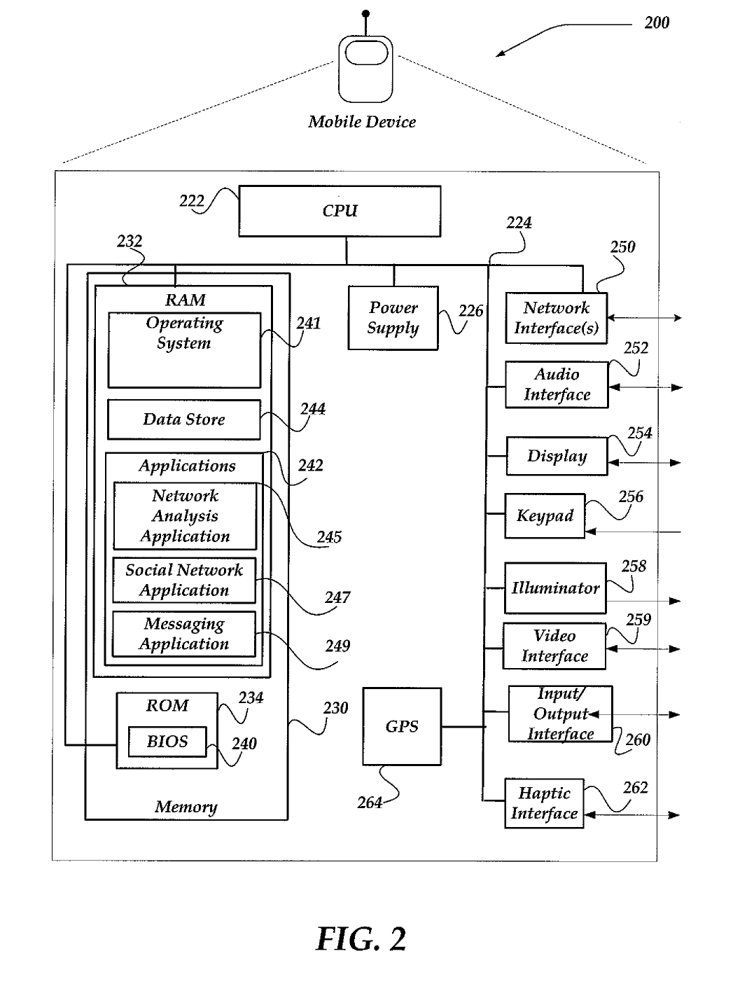

Generally, client devices 102-104 may include virtually any mobile computing device capable of receiving and sending a message over a network, such as wireless network 110, or the like. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. One embodiment of a mobile device usable as one of client devices 102-104 is described in more detail below in conjunction with FIG. 2.

Client device 101 may include virtually any computing device that typically connects using a wired communications medium such as personal computers, multiprocessor systems, microprocessor-based or programmable consumer electronics, network PCs, or the like. In one embodiment, client devices 101-104 may be configured to operate over a wired and/or a wireless network.

Client devices 101-104 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed.

A web-enabled client device may include a browser application that is configured to receive and to send web pages, web-based messages, or the like. The browser application may be configured to receive and display graphics, text, multimedia, or the like, employing virtually any web based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send a message.

Client devices 101-104 also may include at least one other client application that is configured to receive content from another computing device. The client application may include a capability to provide and receive textual content, multimedia information, or the like. The client application may further provide information that identifies itself including a type, capability, name, or the like. In one embodiment, client devices 101-104 may uniquely identify themselves through any of a variety of mechanisms, including a phone number, Mobile Identification Number (MIN), an electronic serial number (ESN), network address, or other device identifier. The information may also indicate a content format that the client device is enabled to employ. Such information may be provided in a message, or the like, sent to another computing device.

Client devices 101-104 may also be configured to communicate a message, such as through email, Short Message Service (SMS), Multimedia Message Service (MMS), instant messaging (IM), Internet relay chat (IRC), Mardam-Bey's IRC (mIRC), Jabber, or the like, between another computing device. However, the present invention is not limited to these message protocols, and virtually any other message protocol may be employed.

Client devices 101-104 may further be configured to include a client application that enables the user to log into a user account that may be managed by another computing device or network, such as a social network or other resource accessible through a server such as one of the servers 107, 109. Such a user account, for example, may be configured to enable the user to receive emails, send/receive IM messages, SMS messages, access selected web pages, participate in a social networking activity, provide messages that may include links or attachments, or the like. However, managing of messages may also be performed without logging into the user account.

A message may be sent using any of a variety of message protocols, including but not limited to SMS, IM, MMS, email, or the like. The recipient of message has the option of responding to the message either by addressing the response to only the sender, addressing the response to all of the recipients along with the sender or selecting particular recipients. The recipient can also forward the email onto others, either directly or through the auspices of a structured social network, for example Yahoo 360 or Facebook or the like. The forwarded message may include a reference to the content, article, or message using, for example, an attachment, a link, a copy of the content, article, or message within the forwarded message, or virtually any other mechanism.

A user's social network can include many different groups, within or without a structured social network. For instance, a user's social network can be any contact within the person's email address book. The address book can be located on the user's mobile device or personal computer, and/or can be hosted and maintained by a server such as a server in or accessed by a structured social network. A person's social network can also include various groups, for instance the individual's contacts can be grouped into work-related contacts, school-related contacts, social contacts, subgroups within one or more structured social networks, and the like. The addresses for these social contacts can be saved within memory in client devices 101-104 or can reside elsewhere within the wide area network/local area network 105 or wireless network 110 or on various servers connected to these networks, for example those of one or more structured social networks of which the user is a member.

The contacts within a user's social network, and members or users of a social network such as a structured social network, can be variously categorized or labeled with different attributes, and this categorization can be known to, or within, the social network. A user's contacts within a social network can also be known to the social network or to an administrative entity of the social network, for example where the social network is a structured social network. The attributes can indicate expertise or interest in particular areas, such as new consumer technologies or music. Attributes can also be negative or indicate absence of interest or expertise, for example different personal preferences of a user or contact or a user or contact's lack of knowledge in particular areas. In example embodiments these attributes can be used to discern degrees of similarity and/or potential affinity between different users in a social network.

Wireless network 110 is configured to couple client devices 102-104 with network 105. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, or the like. Access technologies such as 2G, 3G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. In essence, wireless network 110 may include virtually any wireless communication mechanism by which information may travel between client devices 102-104 and another computing device, network, or the like.

Network 105 is configured to couple the Social Network Server 107 and the Content server 109 with each other and with other computing devices, including but not limited to client device 101, and through wireless network 110 to client devices 102-104. For example, an individual user can use one of the devices 101-105 to contact one or more of the servers 107, 109. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, or the like, in the signal. By way of example, communication media includes wired media such as twisted pair, coaxial cable, fiber optics, wave guides, and other wired media and wireless media such as acoustic, RF, infrared, and other wireless media.

It should be noted that in example embodiments, the client devices 101-104 may also be configured with client applications and with APIs and can be configured and arranged to enable the client device to manage communications within and/or between social networks. For example, the client devices 101-104 can be variously configured to obtain and analyze social network data to identify possible connections that increase a connectivity or other health measure of the corresponding social network, and appear likely to be accepted if suggested to users concerned (based for example on determined affinities or similarities of those users). The client devices 101-104 can also be configured to suggest such possible social connections to a user of the client device or other users in the social network. Thus one or more of the client devices 101-104 can variously take on some or all of the functions and responsibilities described herein with respect to the servers 107, 109. Moreover, in another embodiment, various functions performed by the servers 107, 109 may be distributed across a plurality of network devices or client devices.

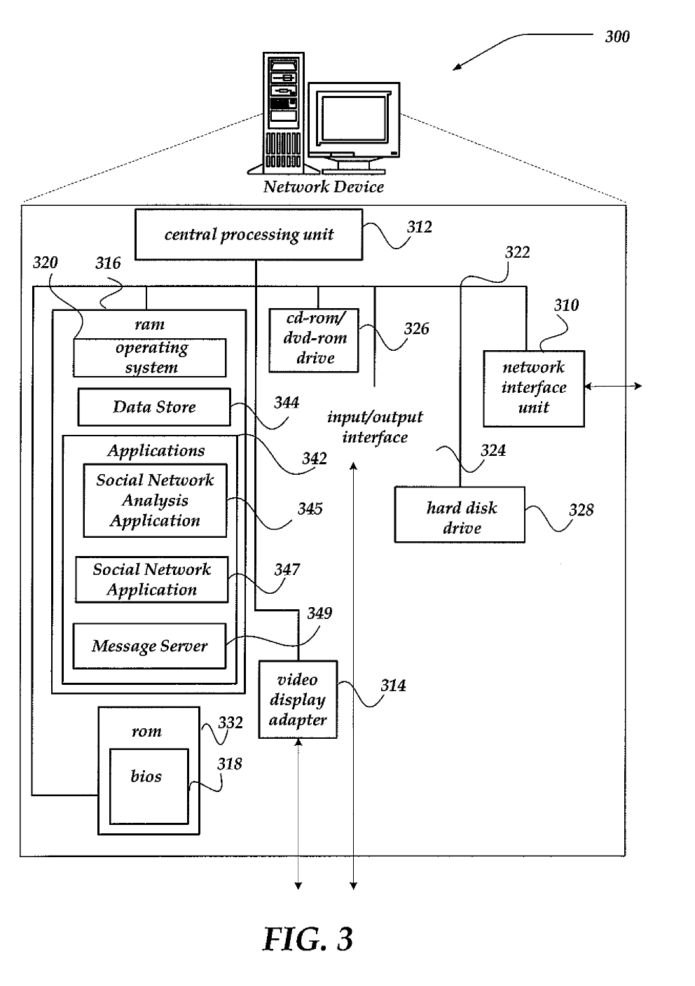

An example embodiment of the servers 107, 109 is described in more detail below in conjunction with FIG. 3. Generally, however, the servers 107, 109 may include any computing device capable of connecting to network 105 to enable managing and administration of a social network, for example a structured social network.

In an example embodiment, the Social Network server 107 collects and analyzes social network data to identify possible connections between users of a social network that would increase a connectivity or other health measure of the social network. The Social Network server 107 also analyzes similarities between users that would be linked by the connections, to determine a probability or other measure with respect to a question of whether the users would accept and implement the connections if they were suggested. The Social Network server 107 can then select and suggest connections to users of the social network based on results of the connectivity and similarity analyses. The server 107 can also receive feedback from users who have received suggestions, for example feedback as to whether the suggestions were accepted or not, and optionally additional information such as if not then why not, or if yes then how successful or satisfactory the connection turned out to be. In an example embodiment the Social Network server 107 can delegate some or all of these functions to the Content server 109. Network resources that can be used to facilitate the similarity analysis can include, for example, any user information, including but not limited to user profiles, names or monikers associated with users, contact information, personal information, geographic and demographic information, content (e.g., images, movies, sound) associated with users, user contacts and friends, interests and affiliations, calendars and so forth.

In one embodiment, the servers 107, 109 can connect to and can represent (or control access to) different structured social networks, and provide one or more interfaces to a user of client devices 101-104. In one embodiment the Social Network server 107 enables management of a social network and provides access to the social network. The Content server 109 can host content or other resources for the social network, and in example embodiment can provide services to one or more of the client devices 101-104 independently of the social network. Interfaces of the servers 107, 109 may be variously used to post, spread, delete, or otherwise manage communication with, and distribution of messages or communication within the social network of the Social Network server 107 and/or with the client devices 101-104. For example, the servers 107, 109 may provide access to an account with a structured social network or to another account, and may request user log-in information before providing access to the account. Such log-in information may include a user name, password, or other identifier of the user and/or client device used by the user. Moreover, the servers 106-109, can be variously configured to manage information for a user, such as an address book, buddy list, or other type of contact list, either in conjunction with a structured social network, or independently.

Devices that can operate as one or more of the Social Network server 107 and the Content server 109 may include, but are not limited to personal computers, desktop computers, multiprocessor systems, microprocessor-based or programmable consumer electronics, network PCs, servers, network appliances, and the like. Moreover, while the servers 107, 109 are illustrated as distinct devices, the invention is not so limited. For example, in one embodiment, the servers 107, 109 may be implemented within a single network device, or distributed across a plurality of network devices.

The servers 107, 109 can include virtually any network computing device that is configured to provide various resources, including content and/or services over network 105. One or more of the servers 106-109 may provide access to any of a variety of content, including, but not limited to messages, such as emails, SMS messages, IM messages; search results; news; articles; websites; hyperlinks; ads; reviews; as well as content that may include audio files, video files, text files, streaming files, graphical files, or the like. Thus, virtually any content may be available through servers 107, 109 (subject to applicable access conditions or restrictions) for access by client devices 101-104. In one embodiment, the servers 107, 109 might be configured and arranged to provide a website for users to post, view, link to, and/or otherwise access, content. Servers 107, 109 might also provide FTP services, APIs, web services, database services, or the like, to enable users to access content. In addition, one or more of the servers 107, 109 may also provide a messaging service, such as an email server, text messaging server, or the like. However, the servers 107, 109 are not limited to these mechanisms, and/or content, and others are envisaged as well.

### Illustrative Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent for example, one of client devices 102-104 of FIG. 1.

As shown in FIG. 1, mobile device 200 includes a processing unit (CPU) 222 in communication with a mass memory 230 via a bus 224. Mobile device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted OPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

In one aspect of the invention, the physical location of the mobile device can be used as an aspect implementing communications, for example selecting which of the Service Users 106-108 the mobile device might initiate communications with, and where multiple Database Service Providers 109 are provided (e.g. for authentication purposes), which of the Providers is to be contacted for authentication or other services on behalf of a user of the mobile device.

Mass memory 230 includes a RAM 232, a ROM 234, and other storage means. Mass memory 230 illustrates another example of computer readable storage media for storage of information such as computer readable instructions, data structures, program modules, or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, the Symbian® operating system, or Y! GO. The operating system may include, or interface with a Java virtual machine module that enables control of hardware components and/or operating system operations via Java application programs.

Memory 230 further includes one or more data store 244, which can be utilized by mobile device 200 to store, among other things, applications 242 and/or other data. For example, a data store 244 may also be employed to store information that describes various capabilities of mobile device 200. The information may then be provided to another device based on any of a variety of events, including being sent as part of a header during a communication, sent upon request, or the like. Moreover, data store 244 may also be employed to store personal information including but not limited to address lists, contact lists, personal preferences, or the like. Data store 244 may also include profile information. In an example embodiment, the data store 244 includes social network information, including but not limited to social network information for one or more users of the social network such as profile information, contacts, and so forth. At least a portion of information in the data store 244 may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. These applications variously enable the mobile device 200 to communicate with networks, websites and other devices, for example any of the servers 107, 109.

The applications 242 can include a social network application 247 that enables the mobile device 200 to act as a part of a structured social network, for example by enabling the mobile device 200 can access network information and perform administrative functions of the social network such as sending messages to other users in the network, forwarding connection suggestions to various users of the network, receiving and responding to information (such as feedback regarding a suggested social connection) or requests from various users including requests for access to resources of the social network, and to can enforce restrictions and permissions for accessing those resources of the social network.

The applications 242 can also include a network analysis application 245, to perform or enable the mobile device 200 to obtain and analyze social network data to identify possible connections between users in the network that increase a connectivity or other health measure of the corresponding social network, and to determine whether a social connection would likely be accepted and exercised if suggested to one or more of the users concerned. The client devices 101-104 can also be configured to suggest such possible social connections to a user of the client device or other users in the social network.

The applications 242 can also include a messaging application 249 that can enable or include a browser application configured to receive and display graphics, text, multimedia, and the like, employing virtually any web based language. In one embodiment, the browser application is enabled to employ Handheld Device Markup Language (RDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web based languages may be employed. The messaging application 249 can be configured to send, to receive, and/or to otherwise process messages using SMS, MMS, IM, email, VOIP, and/or any of a variety of other messaging communication protocols, and can work in conjunction with the social network application 245 in situations where the application 245 is provided and enabled.

### Illustrative Network Device Environment

FIG. 3 shows one embodiment of a network device, according to one embodiment of the invention. Network device 300 may include more components than those shown. The components shown, however, are sufficient to disclose an illustrative embodiment for practicing the invention. Network device 300 may represent, for example, one or more of the servers 107, 109 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer readable storage media. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 342 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, web servers, account management, and so forth.

Applications 342 may include a social network application 347 that enables the network device 300 to act as a part of a structured social network, for example by enabling the network device 300 to access network information and perform administrative functions of the social network such as sending messages to other users in the network, forwarding connection suggestions to various users of the network, receiving and responding to information (such as feedback regarding a suggested social connection) or requests from various users including requests for access to resources of the social network, and enforcing restrictions and permissions for accessing resources of the social network. The social network application 347 can enable the network device 300 to generally support and implement all or part of the social network.

Applications 342 can also include a social network analysis application 345, to perform or enable the network device 300 to obtain and analyze social network data to identify possible connections between users in the network that increase a connectivity or other health measure of the corresponding social network, and to determine whether a social connection would likely be accepted and exercised if suggested to one or more of the users concerned, as described for example further below in the Generalized Operation section and elsewhere herein.

Applications 342 can also include a message server 349 can field messages from other entities such as individual users or other networks or servers, and may include virtually any computing component or components configured and arranged to forward messages from message user agents, and/or other message servers, or to deliver messages to a local message store, such as data store 344, or the like. Thus, message server 349 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, or the like. However, message server 349 is not constrained to email messages, and other messaging protocols may also be managed by one or more components of message server 349. Thus, message server 349 may also be configured to manage SMS messages, IM, MMS, IRC, mIRC, or any of a variety of other message types. Moreover message server 349 may also represent a web server configured to enable access to and/or management of messages. The message server 349 can communicate appropriately with the other applications, for example the applications 345, 347, for example to exchange messages or information.

### Generalized Operation

As noted above, a social network can be healthier and more active when its user population is more active, and when more people in the network interact with each other. Network health can be measured in different ways, including for example average maximally-connected cluster size (bigger is better, since small clusters suggest isolated users); a diameter of a maximally connected component or cluster of the social network (smaller is better, since ideas take less time to propagate through a smaller-diameter network); and a magnitude of the second-smallest eigenvalue of a graph Laplacian of a connectivity matrix representing the social network (this provides a measure of how fast a transition matrix of the social network mixes ideas).

Generally, connections such as relationships, friendships and other communication paths (e.g. newsletters, blogs to which other users subscribe, and so forth) between network users, that increase connectivity of the social network and effectively make the network “smaller”, can benefit the network. For example, increased connectivity can permit or enable information or ideas (e.g., tags, groups, memes) to traverse the network more quickly and thoroughly, thus benefiting the social network.

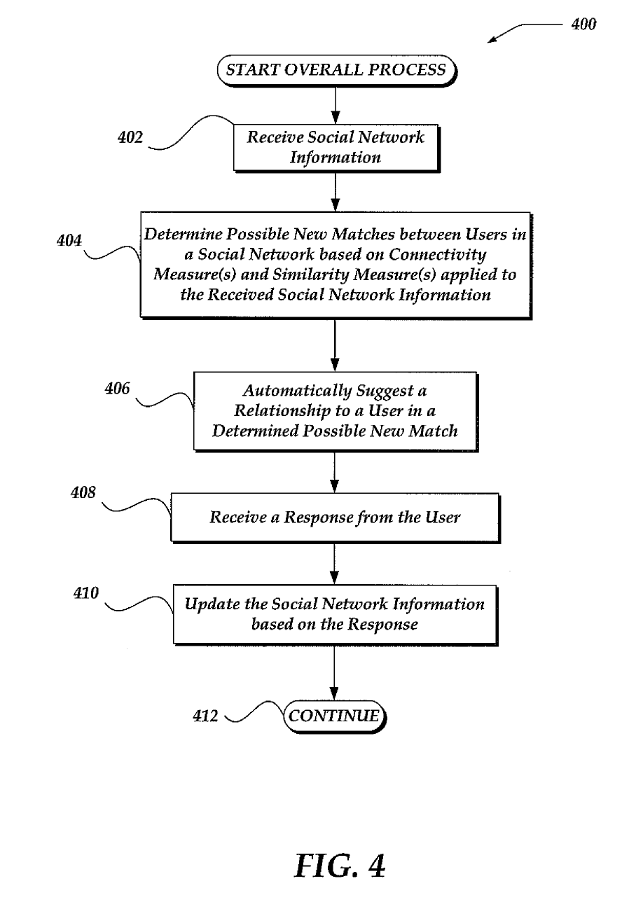

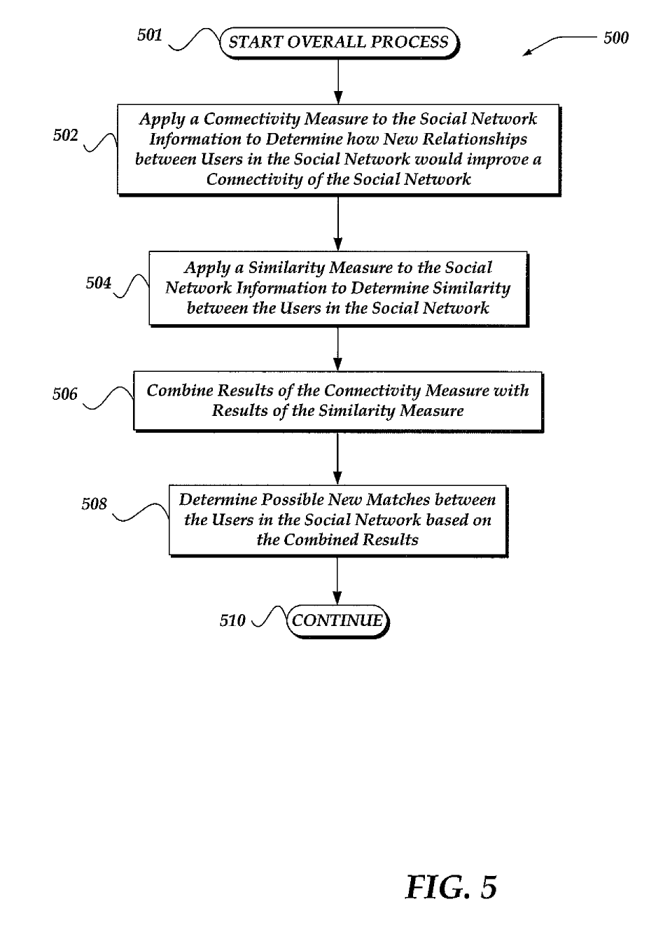

The example processes illustrated in FIGS. 4-5 and described in further detail below, identify possible but unrealized connections or relationships between social network users that would benefit or increase a health of the network, and select among them to suggest particular connections to affected users or participants in the social network to encourage those users to establish and use the connections.

Selections are based for example on similarity measures between social network users identified in the possible connections, because users might not be willing to form or use connections that benefit the network as a whole but do not appear interesting or particularly beneficial to the individual user. Thus similarity is important because an objective of an embodiment of the invention is to select and then propose connections that not only benefit the network as a whole (e.g. by increasing a connectivity of the network), but are also likely to be successful, e.g., favorably received and then consummated by the users that receive suggestions to make the connections. This can enable efficient use of social network resources and avoid annoying users by preventing or reducing suggestions for meaningless or unlikely matches.

FIG. 4 illustrates a logical flow diagram of a process 400 in accordance with an example embodiment. After an initial start block, control proceeds to block 402 where social network information is received. This information includes information about connections or relationships between nodes or users of the social network, and also information about those nodes or users such as their interests, affiliations they may have with particular interest or use groups, content (e.g., music, images, video or movies, text) associated with them, ratings of popularity, expertise, or other characteristics accorded them by other users in the network (e.g. via direct commentary or collective action), and so forth.

Control proceeds from block 402 to block 404, where possible new matches or relationships between users in the social network are determined, based on one or more connectivity measures and one or more similarity measures applied to the social network information. In an embodiment of the invention, this is done by calculating network connectivity measure(s) and user similarity measure(s) using social network information, and then making the determination based on a combination of those measures. FIG. 5 and corresponding description below illustrate an example implementation of block 404 in further detail, in particular with respect to connectivity measures.

With respect to similarity measures, example embodiments can use one or more different kinds information to calculate a similarity measure or determine degrees of similarity between different users in a social network. Relevant similarity information can include, for example, second order contacts that users at endpoints of a contemplated connection have in common (e.g., number of friends in common), and/or a similarity between a user's friends and other users being considered as contacts to suggest, and so forth. Other factors include a threshold number of generally uncommon tags or interests that different users have in common. For example, members who have common interest in a threshold number of uncommon or eclectic things, such as annual “Bring Your Own Big Wheel” events where adults race down hilly San Francisco streets on tricycles, can be considered likely to enjoy or appreciate a suggested connection. A degree of overlap in interests can also be considered, for example a number of interests, use groups, chat rooms and so forth that the users being considered for suggested contact all have or belong to. This can include a minimum threshold to ensure or predict with satisfactory likelihood of success, that there is sufficient common ground that the users would favorably consider a suggested connection. In an example embodiment, a maximum threshold can also be applied, where one or more degrees of similarity such as number of groups or interests in common that is above the maximum threshold, can indicate that the users likely already know or are aware of each other, and do not desire a connection or relationship. Thus, block 404 can include omitting possible matches that would increase connectivity of the social network but are likely to suggest contacts between users that already know each other.

In example embodiments other similarity factors can be additionally or alternatively considered. For example, in social networks where images such as photographs or other content (e.g. music, blogs, and so forth) are associated with different users, contacts can be suggested between users whose content shares similar ratings, and where the ratings are optionally higher than a minimum threshold. The ratings can indicate quality, popularity, average interestingness, or any other measure or criterion or blend of criteria. Thus, a user that is considered to be an expert of a given rank or class, or an owner of content of a given quality or popularity level, can be suggested as a contact to another user of similar rank or level. Similarity of the content itself can also form a basis of similarity. These ratings can for example be provided by other users in the network via popular vote or feedback and/or can be determined by the social network based on user or traffic flow within the network (e.g., number of hits or views within a particular time period), and can thus be considered “social” ratings that are derived from actions of multiple users. Tags for the content such as image tags (e.g. text that users apply as descriptive and/or whimsical labels for their photographs) can also be considered and compared or evaluated, and common content or content that users have commented or marked as favorites in common (e.g., photographs) can also be used to evaluate similarity or potential affinity between users. Asymmetry can also be used or considered when selecting potential connections to suggest. For example, if Bob and Alice have intersecting interests but Bob has a larger number of non-intersecting interests than Alice, then Bob can be suggested to Alice (e.g., Alice can be invited to contact Bob) but not vice-versa. In addition, people that are members of similar but different groups can be paired. Different kinds of similarities can be considered individually, or in combination.

Returning now to FIG. 4, control proceeds from block 404 to block 406, where the determined new possible connections are automatically suggested to one or more users identified in the connections. The suggestion can be conveyed via an email message, a display on a web page, or any other message or communication such as an alert when a user logs in to a social network, and can include a hyperlink or other mechanism by which the user can easily and quickly accept and initiate the suggested connection, for example by sending or authorizing a message to another user or group identified in the suggested connection, where for example the message identifies one or more of the initiating user, a reason for the message, an indication or authentication of who suggested the contact in the first place, a confidence level of the suggesting entity that the contact will be mutually or individually useful and agreeable to the users, and so forth.

Control then proceeds from block 406 to block 408, where a response or reply to the suggestion or invitation is received from the user to whom it was sent or otherwise provided. The response can be a message such as an email message, the user's selection of an option on a web page, or any other communication or provision of information from the user. This response or reply from the user can indicate for example whether the user accepted or declined the suggestion, whether the user's initial communication to another user identified in the suggestion was accepted or rebuffed, and so forth. The reply can also include feedback from the user indicating the user's satisfaction and/or constructive comments regarding the suggestion, and/or the user's experience in exchanging communication with another user identified in the suggestion and resulting satisfaction. The user to whom the suggestion was made can also remark on the basis for the suggestion (e.g. if articulated or described in the suggestion), for example can say “please continue to recommend other users based on my interest in local opera”, or “please do not consider my interest in photography when suggesting new contacts”. Similar feedback can also be received from suggested users. Note that thresholds or weightings of similarity measures or factors can be adjusted, for example, based on such feedback from users, to refine or achieve desired rates or percentages of successful acceptance of the suggestion by the user receiving it, and/or consummation of the suggested contact (e.g. acceptance by both or all involved users that make up the suggested connection).

Control then proceeds from block 408 to block 410, where information for the social network, for example information that is or will be used in block 404 to determine possible new matches, is updated based on the reply of block 408. For example, that a suggested contact has been established (and thus changed the network and improved its connectivity), or that a suggested contact has been declined and should not be repeated, indefinitely or for a given time period. Social network information used in block 404 can also be automatically updated where the social network automatically monitors connections between or among its users, for example by monitoring users' contact lists, group memberships, affiliations, and so forth.

Control finally proceeds from block 410 to block 412 where the process continues, for example by looping back to block 402 or embarking upon other operations.

In an embodiment, only one match or suggested connection is handled in block 406, so that possible connections are recomputed between each proposal or suggestion. In another embodiment, multiple possible connections are proposed or suggested before possible connections are recomputed or determined, or in other words without intervening computation of possible new network connections.

FIG. 5 illustrates an example implementation 500 of block 404 of FIG. 4. After beginning in block 501, control proceeds to block 502, where a connectivity measure is applied to social network information to determine how new relationships would improve a connectivity of the network, or for example which new relationships would provide greatest improvement in connectivity.

Connectivity can be measured and evaluated in a variety of different ways. For example, an average “influence” of users can be measured and evaluated, using network influence models. Such models describe a probabilistic process in which a meme spreads virally through a social network, according to transition probabilities on all the edges of a graph representation of the network. The influence of a user can be measured as an expected number of users who have the meme after the process terminates. By adding edges to maximize influence of all users, overall information in the graph (i.e. the social network) can be increased. Thus, such edges can be identified as possible contacts or connections between users of the social network that are candidates for suggesting to the network users.

In another embodiment, an eigenvalue analysis technique can be adapted to efficiently indicate or identify possible social network connections that provide maximum increase in connectivity of the network. For example, second-smallest eigenvalues of a graph Laplacian that represents the social network can be evaluated. The second-smallest eigenvalues indicate an algebraic connectivity of the graph or social network, and candidate network connections or edges of the graph that have a largest difference in corresponding Fiedler vector values (where Fiedler vectors are normalized eigenvectors) can indicate connections that would provide greatest increases in network connectivity. In other words, in an example embodiment graph edges or social network connections that maximally increase connectivity of the graph or network can be identified by finding edges or connections that result in largest differences between elements vᵢ, vⱼ of Fiedler vectors corresponding to second-smallest eigenvalues of the graph Laplacian representing the social network, where the subscripts i, j represent two endpoints of the graph edge or two users to linked by connection in the social network.

In an embodiment, the connectivity measure is applied with an assumption that links or connections between users in the social network are not directed, e.g. are not unidirectional.

Control proceeds from block 502 to block 504, where a similarity measure is applied to the social network information, to determine similarity between users of the network and by extension, to discern whether given users in the social network would be receptive to suggested connections or contacts. As noted in detail with respect to FIG. 4, a variety of factors and information can be considered and evaluated when applying one or more similarity measures.

Control proceeds from block 504 to block 506, where results of the connectivity and similarity measures are combined. This can be done in different ways. In an embodiment, the connectivity measure and the similarity measure are multiplied to form a combined measure or probability of “engagement”, e.g., P_E(pi+k) where an objective is to maximize the probability of engagement P_E(pi+k) over all possible edge sets k (connections between network users) where pi is a set of existing edge sets in graph of the network. The probability of engagement P_E can be given by multiplying two terms, one connectivity and the other of similarity, so that P_E=C(pi+k)*P(k_ij), where C( ) is a measure of how well the network would be connected if it had additional connection(s) k, and P( ) is a measure of probability of how similar network users i, j are (or, how likely they are to accept and/or consummate a proposed connection between them). In an embodiment, the two measures that form the probability of engagement can be variously weighted, for example P_E=C( )^{S}*P( )^{T} where the S, T, are non-zero values. Generally, the probability of engagement can be formed by any combination or function of connectivity and similarity measures, for example P_E=e(C, S) where e is some function of the connectivity measure C and the similarity measure S. In an embodiment, network influence model or eigenvalue analysis techniques are applied to determine the connectivity measure C. When these techniques, a greedy algorithm can be used where at each step one edge or network connection is added to maximize a combined measure of connectivity and similarity (e.g., to maximize a probability of engagement).

Control proceeds from block 506 to block 508, where possible new matches or connections between users in the social network are determined, that would both improve connectivity of the social network and likely be accepted by users to whom they are suggested. Possible new matches or connections can be for example be determined by selecting matches or connections that have probability of engagement that exceeds a threshold value. In block 508, matches can also be omitted or removed from consideration, if it is likely that users identified in a possible connection already know each other (e.g., have greater than a threshold number of interests, group memberships, and the like in common).

Control proceeds from block 508 to block 510, where the process ends or continues to another process or operation, for example block 406 of FIG. 4.

It will be understood that the actions shown in FIGS. 4-5 can be performed in different orders than those shown, and can be variously combined or modified by adding other actions or selectively omitting illustrated actions in accordance with specific circumstances and applications.

It will also be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention. Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

### Example Eigenvalue Analysis Technique

In an example embodiment, a heuristic technique or algorithm is employed to embed the social network connection data in a line and then look at distances on the line as a surrogate for distances in a graph corresponding to the network. More specifically, a connectivity graph or connectivity matrix A is first created, where nodes of the graph are people (e.g., social network users) and edges of the graph represent some sort of interaction, connection or relationship between pairs of the people. This matrix can be thought of as having mostly nonzero entries, i.e., the corresponding graph has very few edges, since most pairs of people will not be connected. The links or edges can either be thresholded to {0,1}, indicating that there exists a connection between a given pair of people according to some measure, or the edges can be weighted, e.g., by traffic or some other characteristic that can be quantitatively measured, to indicate an intensity of the connection. The goal is to suggest new connections that will be accepted. This can be done by decomposing the problem into two steps.

In the first step, we compute a distance function between pairs of people such that pairs of people with closer connection will be closer and people with weaker connection will be farther apart. In the second step, we attempt to identify pairs of people who are far apart, but who we think are more similar and thus who would be likely to accept a suggested connection. For example, we wish to find the edge between two users that when added will produce the greatest change in the overall diffusion of the graph. This kind of graph analysis can be difficult, but we can find an approximate solution by taking the first derivative of the Fiedler vector.

To deal with the first step, it is possible to apply the heuristic to embed or map the graph onto a line. The Laplacian matrix L is formed corresponding to the graph—this matrix is defined whether or not the edges are weighted—and then we consider the first nontrivial eigenvector of this matrix. Let vᵢ denote the value of this vector for the i^{th} person, i.e., the i^{th} node or coordinate in the vector. Then, if there are n people, we have n² coordinate-differences. We do not want to form the matrix consisting of those differences, but we can implicitly access the (i,j) element of that matrix by taking vᵢ−vⱼ. Let us define c_{{ij}}=|vᵢ−vⱼ| (or define c_{{ij}}=(vᵢ−vⱼ)²) to be the connectivity score for that pair of users. Similarly, let us assume that we have a similarity matrix whose (i,j) element is denoted by s_{{i,j}}. This encodes information about how similar the pair of users is, or how likely we think they will be to accept a suggested connection. Note that if there are disconnected pieces in our adjacency matrix, then we can look at all eigenvectors except the constant eigenvector, corresponding to eigenvalue 0, and proceed in a manner analogous to that just described.

To determine which suggestions to make, two procedures can be used. First, we can define some function ƒ=ƒ(c,s) that depends on the connectivity scores c determined from the heuristic and similarity scores s that we have from other information. One choice can be to let ƒ=c^{α}s^{β} element-wise. Note that this multiplicative form would return a value of ƒ_{{ij}}=0 if either c_{{ij}}=0 or s_{{ij}}=0.

Second, we can alternatively start with the pair of nodes with the largest value for c_{{ij}} and have a rule for deciding whether to suggest them. For example, we could suggest them if their value for s_{{ij}} is above some user-determined threshold value. If we decide not to suggest them, then we go to the pair of nodes with the second largest value for c_{{ij}} and iteratively make the same decision. If we decide to suggest them and the suggestion is accepted, then we can re-compute the Laplacian eigenvector and iteratively continue. Note that a special case of this framework is when there is a cost associated with making a suggestion. This could be modeled by a cost matrix with entries γ_{{ij}}. In this case, rather than considering just the difference between entries in the Laplacian eigenvector, an extension of the heuristic can consider frac{(γᵢ−γⱼ)²}{γ_{{ij}}}, i.e., to consider a mapping or embedding into the line in which we weight the difference between pairs of people in a natural way. This simply corresponds to the choice β=−1 in our suggested functional form above.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected is:

1. A network device configured to manage a social network, comprising:
a transceiver to send and receive data over a network; and
a processor that is operative to enable actions for:
determining possible new matches between users in the social network based on at least one connectivity measure and at least one similarity measure applied to social network information, wherein the social network information includes user profile information and indicates existing social relationships between the users in the social network; and
automatically notifying at least one user in a determined possible new match to suggest a relationship between the at least one user and an other user identified in the determined possible match.

2. The network device of claim 1, wherein the processor is operative to enable further actions for:
applying a connectivity measure to the social network information to determine how new relationships between users in the social network would improve a connectivity of the social network;
applying a similarity measure to the social network information to determine degrees of similarity between the users in the social network;
combining results of applying the connectivity measure with results of applying the similarity measure; and
determining the possible new matches between the users in the social network based on the combined results.

3. The network device of claim 1, wherein the processor is operative to enable further actions for:
receiving a response from the at least one user in the determined possible match, wherein the response indicates whether the at least one user has declined or consummated the suggested relationship;
updating the social network information based on the response; and
repeating the step of determining.

4. The network device of claim 1, wherein the social network comprises users that are members of other social networks, and the social network information includes information from the other social networks.

5. The network device of claim 1, wherein the similarity measure indicates degrees of similarity between users in the social network based on at least one of:
shared second degree contacts;
a quality or social network ranking of photographs belonging to the users that is above a threshold value; or
at least a threshold number of user tags in common wherein the tags are uncommon within the social network.

6. The network device of claim 1, wherein the determining comprises:
omitting from the determined possible new matches, possible matches between users that belong to each of a plurality of social groups, wherein a number of the social groups in the plurality exceeds a threshold value.

7. The network device of claim 1, wherein a possible new match between two users in the social network is determined when a combination of the at least one connectivity measure and the at least one similarity measure exceeds a predetermined threshold value.

8. A method for managing a social network, comprising:
determining possible new matches between users in a social network based on at least one connectivity measure and at least one similarity measure applied to social network information, wherein the social network information includes user profile information and indicates existing social relationships between the users; and
automatically notifying at least one user in a determined possible new match to suggest a relationship between the at least one user and an other user of the determined possible match.

9. The method of claim 8, wherein the determining comprises:
applying a connectivity measure to the social network information to determine how new relationships between users in the social network would improve a connectivity of the social network;
applying a similarity measure to the social network information to determine degrees of similarity between the users in the social network;
combining results of applying the connectivity measure with results of applying the similarity measure; and
determining the possible new matches between the users in the social network based on the combined results.

10. The method of claim 8, further comprising:
receiving a response from the at least one user in the determined possible match, wherein the response indicates whether the at least one user has declined or consummated the suggested relationship;
updating the social network information based on the response; and
repeating the step of determining.

11. The method of claim 8, wherein:
the social network comprises users that are members of other social networks, and the social network information includes information from the other social networks;
the similarity measure indicates degrees of similarity between users in the social network based on at least one of shared second degree contacts, a social rating of content common to the users that is above a threshold value, or a minimum number of user tags in common wherein the tags are uncommon within the social network; and
the determining comprises omitting from the determined possible new matches, possible matches between users that belong to each of a plurality of social groups, wherein a number of the social groups in the plurality exceeds a threshold value.

12. A processor readable medium that includes data and instructions, wherein the execution of the instructions provides for managing a social network by enabling actions, comprising:
determining possible new matches between users in a social network based on at least one connectivity measure and at least one similarity measure applied to social network information, wherein the social network information includes user profile information and indicates existing social relationships between the users; and
automatically notifying at least one user in a determined possible new match to suggest a relationship between the at least one user and an other user of the determined possible match.

13. The processor readable medium of claim 12, wherein the determining comprises:
applying a connectivity measure to the social network information to determine how new relationships between users in the social network would improve a connectivity of the social network;
applying a similarity measure to the social network information to determine degrees of similarity between the users in the social network;
combining results of applying the connectivity measure with results of applying the similarity measure; and
determining the possible new matches between the users in the social network based on the combined results.

14. The processor readable medium of claim 12, wherein the actions further comprise:
receiving a response from the at least one user in the determined possible match, wherein the response indicates whether the at least one user has declined or consummated the suggested relationship;
updating the social network information based on the response; and
repeating the step of determining.

15. The processor readable medium of claim 12, wherein:
the social network comprises users that are members of other social networks, and the social network information includes information from the other social networks;
the similarity measure indicates degrees of similarity between users in the social network based on at least one of shared second degree contacts, a social rating of content common to the users that is above a threshold value, or a minimum number of user tags in common wherein the tags are uncommon within the social network; and
the determining comprises omitting from the determined possible new matches, possible matches between users that belong to each of a plurality of social groups, wherein a number of the social groups in the plurality exceeds a threshold value.

16. A system that manages a social network, comprising:
a network device that includes:
a transceiver for communicating with at least one mobile device over a network; and
processor for enabling actions, comprising:
determining possible new matches between users in the social network based on at least one connectivity measure and at least one similarity measure applied to social network information, wherein the social network information includes user profile information and indicates existing social relationships between the users; and
automatically sending a message to at least one user in a determined possible new match via the at least one mobile device to suggest a relationship between the at least one user and an other user of the determined possible match; and
the at least one mobile device that further includes:
a transceiver for communicating with at least the network device over the network; and
a processor for enabling actions, comprising:
receiving the message.

17. The system of claim 16, wherein the actions enabled by the network device processor further comprise:
receiving a reply message from the at least one user in the determined possible match, wherein the reply message indicates whether the at least one user has declined or consummated the suggested relationship;
updating the social network information based on the reply message; and
repeating the step of determining.

18. The system of claim 1, wherein:
the social network comprises users that are members of other social networks, and the social network information includes information from the other social networks;
the similarity measure indicates degrees of similarity between users in the social network based on at least one of shared contacts, a social rating of content common to the users that is above a threshold value, or a minimum number of user tags in common wherein the tags are uncommon within the social network; and
the determining comprises omitting from the determined possible new matches, possible matches between users that belong to each of a plurality of social groups, wherein a number of the social groups in the plurality exceeds a threshold value.

19. A mobile device configured to manage a social network, comprising:
a transceiver to send and receive data over a network; and
a processor that is operative to enable actions for:
determining possible new matches between users in the social network based on at least one connectivity measure and at least one similarity measure applied to social network information, wherein the social network information includes user profile information and indicates existing social relationships between the users in the social network; and
automatically suggesting to at least one user in a determined possible new match, a relationship between the at least one user and an other user identified in the determined possible match.

20. The mobile device of claim 19, wherein the processor is operative to enable further actions for:
receiving a response from the at least one user in the determined possible match, wherein the response includes at least one of an indication that the suggested relationship was declined, an indication that the suggested relationship was consummated, or an indication of a satisfaction of the at least one user in the determined match with respect to the suggested relationship;
updating the social network information based on the response; and
repeating the step of determining.

21. The mobile device of claim 19, wherein the social network comprises users that are members of other social networks, and the social network information includes information from the other social networks.

22. The mobile device of claim 19, wherein:
the similarity measure indicates degrees of similarity between users in the social network based on at least one of shared second degree contacts, a quality or social network ranking of photographs belonging to the users that is above a threshold value, or at least a threshold number of user tags in common wherein the tags are uncommon within the social network; and
the determining comprises omitting from the determined possible new matches, possible matches between users wherein the at least one similarity measure exceeds a threshold value that represents a probability that that users in the omitted matches already know each other.

23. The mobile device of claim 19, wherein:
a possible new match between two users in the social network is determined when a combination of the at least one connectivity measure and the at least one similarity measure exceeds a predetermined threshold value; and
the combination comprises a product of the at least one connectivity measure and the at least one similarity measure.
